(19) United States
(12) Patent Application Publication
(10) Pub. No.: US 2017/0014827 A1
(43) Pub. Date: Jan. 19, 2017

(54) Combined Clamping and Supporting Ring for a Reaction Vessel

(71) Applicant: Blacktrace Holdings Limited, Royston (GB)

(72) Inventors: Mark Gilligan, Royston (GB); Oliver Sowerby, Radwinter (GB); Paul Crisp, Elsworth (GB); Andrew Lovatt, Cambridge (GB); Geoff Farmer, Stotfold (GB)

(21) Appl. No.: 15/211,420

(22) Filed: Jul. 15, 2016

(30) Foreign Application Priority Data
Jul. 17, 2015 (GB) 1512608.9

(51) Int. Cl. B01L 9/00; F16B 2/06; F16M 11/04

(52) U.S. Cl. CPC B01L 9/50; F16M 11/041; F16B 2/065

(57) ABSTRACT

A combined clamping and supporting ring for a reaction vessel having a radial flange at a junction between a vessel body and a vessel lid. The ring is capable of clamping around the flange to clamp the lid to the body and support the reaction vessel. The ring comprises a two-part collar comprising a U-shape main portion wide enough at one end to receive the flange of the reaction vessel in a direction parallel to the plane of the ring and a closure portion moveable with respect to the main portion to dose the collar. The collar has at least one support that fits under the flange of the reaction vessel to support the reaction vessel, and at least one clamping member that is arranged to engage above and below the flange to clamp the lid to the body when the collar is closed. At least two supports are provided in the main portion, one on each side of the U-shaped main portion. These supports extend to in front of the centre of the ring towards one end such that they are positioned in front of a notional median plane perpendicular to the direction of insertion through the centre of the reaction vessel in the clamped position.

### RELATED APPLICATION

This application claims priority from UK Patent Application No. 1512608.9 filed on Jul. 17, 2015, the contents of which are incorporated herein by reference in its entirety.

### BACKGROUND

The present inventive concepts are concerned with a combined clamping and swooning ring for a reaction vessel.

Such reaction vessels are typically used on a bench top in chemistry laboratories or may be floor standing in a chemical processing plant. Typically applications include carrying out chemical reactions to synthesise pharmaceutical compounds during the process development of a drug or during manufacture. They are primarily used for carrying out liquid-chemical reactions by may also be used for liquid-solid reactions, gas-liquid reactions, crystallisation, workup, purification, evaporation, stirring, dissolving, mixing and extracting operations. Typically reactors range in volume from 100 ml to 100 l. They are typically fabricated from glass, although other materials such as stainless steel and Hastelloy are also common. The reaction vessels consist of a vessel body and a lid (as shown in FIG. 1) which each have an annular flange, in use, positioned either side of a gasket seal. Typically, a clamping ring such as that shown in FIG. 2 which uses an over centre coupling would be used in order to clamp the flanges together. A separate arrangement is then provided to support the vessel.

An improvement of this design is shown in FIGS. 3 and 4 which represent our own earlier combined clamping and support ring. This has a fixed ring 1 with an internal opening 2 with a number of flat surfaces 3. The flange on the reaction vessel is provided with a complimentary shape of flap such that the vessel is placed into the opening 2 and is rotated about an axis perpendicular to the plane of FIG. 4 so that the flanges on the vessel are supported by the surfaces behind the flaps 3. The clamping screw 4 is connected via an internal mechanism (not shown) to three floating clamping members 5 such that tightening of the clamping screw 4 causes the clamping structures 5 to move radially inwardly in order to damp the flange of the reaction vessel. The ring 1 has a pair of holes 6 which are supported on a stand such that the reaction vessel can be both supported and clamped by the ring. This significantly improves the ease of use of the ring. The reaction vessel can be lifted and rotated into position along with the lid and then simply clamped with the screw. The weight of the vessel is supported by the ring eliminating the need for a separate supporting device. The reaction vessel lid can be removed from the reaction vessel without having to remove any other part of the assembly. To that extent, this design is a big improvement over the prior art. However, one drawback of this design is that it requires a specific configuration of the reaction vessel.

### SUMMARY

The present inventive concepts aim to preserve the above advantages in a combined clamping and supporting ring which can work with standard reaction vessel designs.

According to a first aspect of the present inventive concepts there is provided a combined clamping and supporting ring according to claim 1.

Such an arrangement provides a collar which is capable of both supporting and clamping the reaction vessel. Further, the fact that it has a U-shape main portion that receives the flange of the reaction vessel in a direction parallel to the plane of the ring means that the arrangement of flats of the prior art is not needed such that the collar is capable of supporting a standard reaction vessel with an annular flange.

The closure portion may be a separate member which is separately fixed to the main portion. However, preferably, the closure portion is connected at one end to the main portion by a hinge. This makes the process of bringing the closure mechanism into place very simple and also ensures that it is correctly aligned.

The closure portion may be connected to the main portion by an over centre type of attachment such as that shown in FIG. 2. However, preferably, the closure portion is connected to the main portion at the end opposite the first end by a screw threaded fastener. This provides a mechanism for enabling a user to apply a readily adjustable clamping force to the reaction vessel.

The screw threaded fastener may be threadedly engaged with both the main portion and the closure portion. However, preferably, the screw threaded fastener has a screw threaded portion that engages with the main portion and a head that abuts against the closure portion. This provides a simple and robust attachment.

The screw threaded portion that engages with the main portion preferably engages with a component which is rotatably mounted within the main portion such that the fastener can be swung into place to engage in a groove in the closure member before the head is screwed to abut against the closure portion. Particularly when combined with the hinged closure portion, such an arrangement provides the best unencumbered access for the reaction vessel into the main portion whilst still providing a simple and robust clamping arrangement.

There may be any number of clamping members. However preferably, there are three clamping members as this will ensure that all clamping members engage with the reaction vessel. The clamping members are preferably floating to ensure even distribution of the clamping force during the clamping process. Each clamping member may have two contact points in order to distribute the clamping load.

In the broadest sense, there may be only one support, but this would have to extend around a significant portion of the periphery of the flange which would require careful designing to avoid interference with the clamping members. Therefore, preferably, there are a plurality of supports distributed around the collar. Ideally, there are two supports, one on each side of the U-shape main portion.

The clamping ring may be configured such that part of the upper portion of the ring is removable to allow the lid to be removed. Alternatively, it may be configured such that the reaction vessel has to be removed from the ring in order to remove the lid. However, preferably, the support is arranged such that it is closer to the one end of the ring than the or each clamping member to support the flange in a second position which is closer to the one end of the ring than the position in which the flange is clamped, and in which the clamping member does not engage with the flange to allow removal of the vessel lid. This allows the reaction vessel to be slid forward to the second position in which it is still supported by the support, but in which the lid can be removed as it is free of the clamping member.

According to a second aspect of the present inventive concepts there is provided a stand comprising a base arranged to support the stand on a horizontal surface, a supporting arm attached to the base at one end and to a combined clamping and supporting ring according to the first aspect of the inventive concepts at the opposite end.

Preferably, the ring is supported by the arm at the side of the ring opposite to the closure portion. This makes it easy for the reaction vessel to be simply loaded onto the front of the stand.

### BRIEF DESCRIPTION OF THE DRAWINGS

An example of a combined clamping and supporting ring and a stand will now be described with reference to the accompanying drawings, in which:

FIG. 1 is a exploded cross-section of the reaction vessel to which the inventive concepts can be applied;

FIG. 2 is a perspective view of a conventional clamping ring;

FIG. 3 is a perspective view of a prior art combined clamping and supporting ring;

FIG. 4 is a plan view of the ring show in FIG. 3;

FIG. 5 is a perspective view of a stand according to the present inventive concepts with a reaction vessel in place;

FIG. 6 is a perspective view of a combined clamping and supporting ring according to a first example of the present inventive concepts;

FIG. 7 is a plan view of the ring of FIG. 6;

FIG. 8 is a side view of the ring of FIGS. 6 and 7;

FIG. 9 is a perspective view from the opposite side of the ring of FIG. 6;

FIG. 10 is a perspective view from the same angle as FIG. 9 showing the ring in a partially open configuration;

FIG. 11 is a view similar to FIG. 10 showing the ring in a fully open configuration;

FIG. 12 is a perspective view of the stand and the reaction vessel showing the ring in the position of FIG. 10;

FIG. 13 is a detailed view of the top part of FIG. 12;

FIG. 14 is a simplified plan view of the example of FIGS. 5 to 13 showing the clamping and support points;

FIG. 15 is a simplified plan view similar to FIG. 14 showing a second example of the present inventive concepts; and

FIG. 16 is a simplified plan view similar to FIGS. 14 and 15 showing a third example of the present inventive concepts.

FIG. 17 is a perspective view of the main portion of the ring of FIG. 16:

FIG. 18 is a view similar to FIG. 17 showing an alternative version of the main portion; and

FIGS. 19 is a view similar to FIGS. 17 and 18 showing a further alternative main portion.

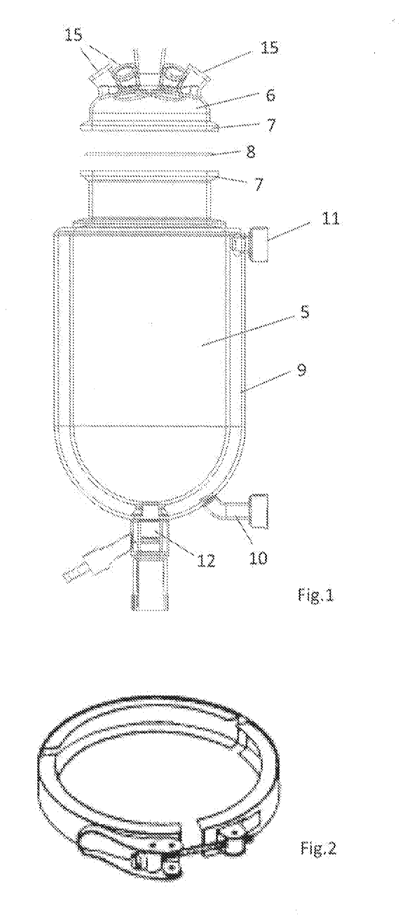

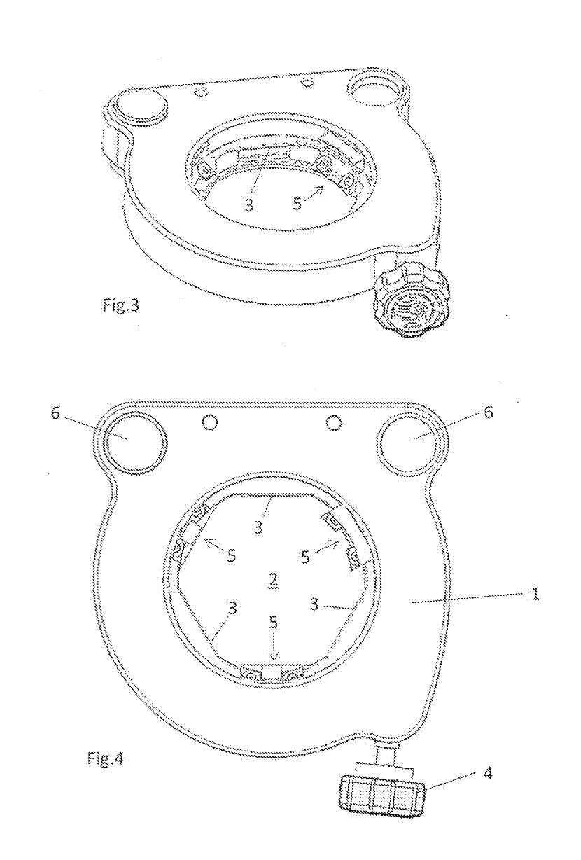

### DETAILED DESCRIPTION OF EMBODIMENTS

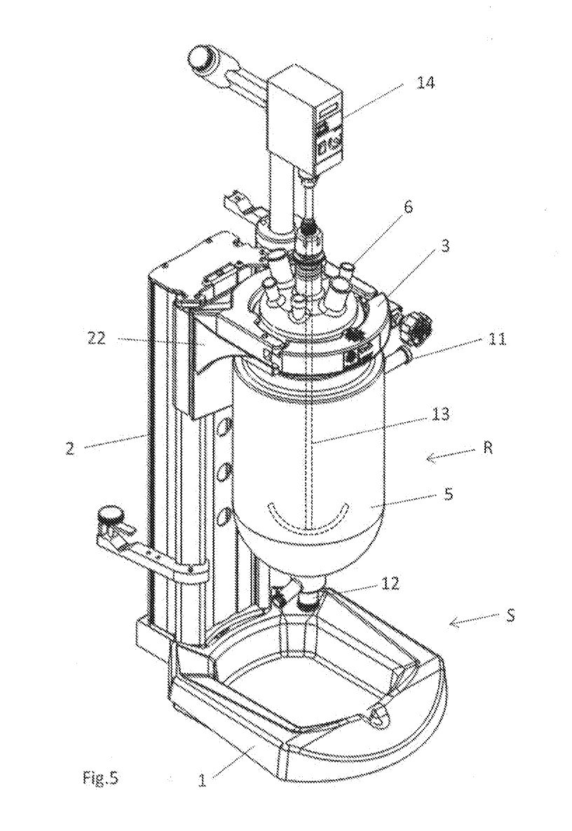

FIG. 5 shows the overall arrangement of the stand S and reaction vessel R. The stand has a base 1, an upstanding support arm 2 and a combined clamping and support ring 3.

The reaction vessel comprises a vessel body 5 and a lid 6 which both have a flange 7 as best shown in FIGS. 1, 12 and 13 where they are sealed by a gasket 8.

The reaction vessel has a number of additional connections or known features such as a jacket 9 for thermoregulation fluid, an inlet port 10 for thermoregulation fluid, outlet port 11 for thermoregulation fluid, and a reaction vessel outlet 12. The stand can also accommodate ancillary equipment as is well known in the art, such as a stirrer 13 and the associated stirrer drive motor 14. The lid 6 has various ports 15 that can accommodate additional ancillary equipment such as sensors and sampling lines.

The present inventive concepts concern the novel combined clamping and supporting ring 3. A first example is shown in FIGS. 5 to 14.

The ring 3 has a generally annular shape and is made up of two main parts, namely a U-shaped main portion 20 and a closure portion 21. The U-shaped main portion preferably has an opening that is between 100 mm and 500 mm wide and more preferably 130 to 180 mm wide. The main portion 20 is provided with a pair of support flanges 22 (FIG. 5) by which it is attached to the support arm 2 such that it is located above the base 1. The ring 3 is provided with three clamping members which are spaced generally equally around the ring 3. Two of the clamping members 23 are in the main portion 20 and the third one 24 is in the closure portion 21. The clamping members 23, 24 have tapered upper and lower surfaces such that as they are brought radially inwards, they exert a clamping force on the flanges 7 on the body 5 and lid 6. The clamping members 23, 24 are preferably made of PEEK, but can be made of any suitable material and may have cushioning inserts if necessary.

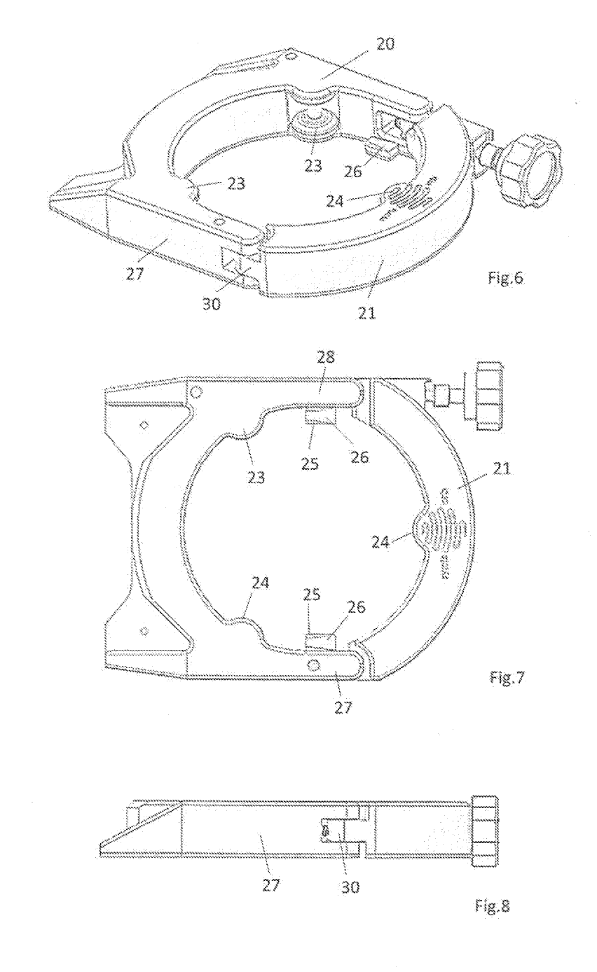

Two supports 25 are provided towards the lower face of the ring 3, one on either side of the U-shaped main portion 20 at around the widest part of the opening. As best seen in FIG. 6, the supports 25 have a ramped upper surface 26 to receive the flange 7 on the body 5.

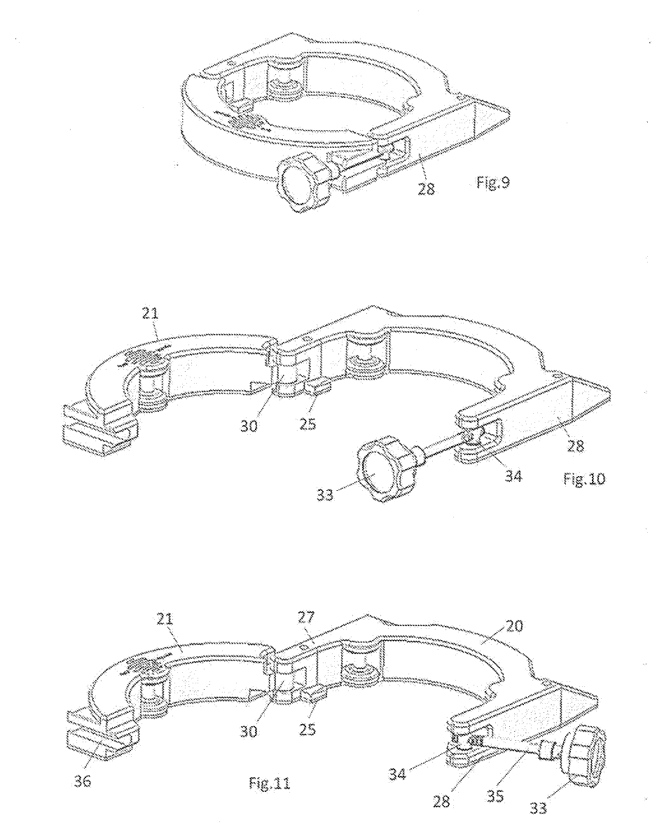

The closure portion 21 has a hinge 30 at one end by which it is connected to a first arm 27 of the main body 20 such that it can be swung into position to connect with a second arm 28 of the main portion 20 which is opposite to the first arm 27 as described below. At the free end of the second arm 28 is a clamping screw 31 comprising a screw threaded portion 32 and a head 33. The screw threaded portion 32 is threaded into a nut 34 which itself is rotatably mounted in the arm 28 as is apparent from FIGS. 10 and 11.

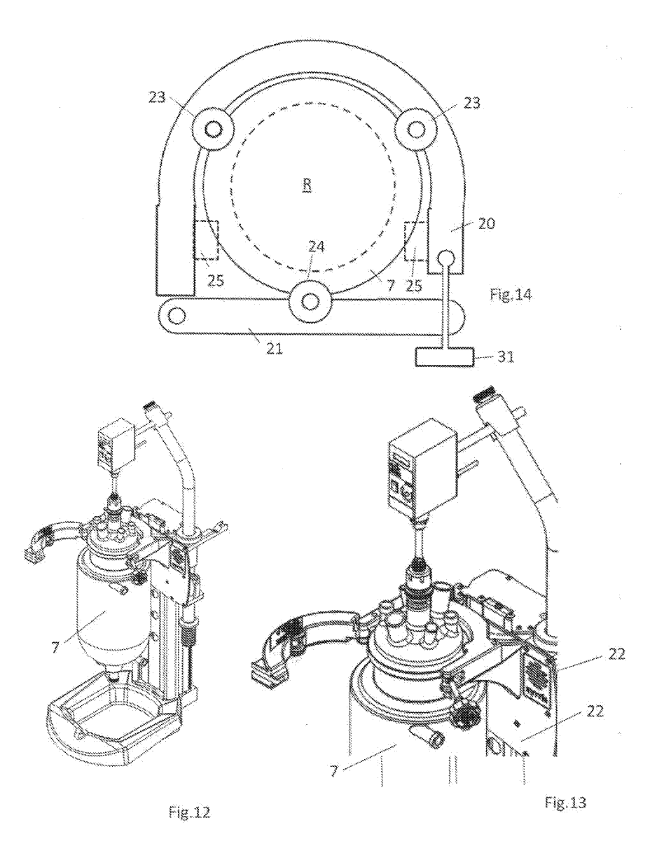

In order to fully open the ring 3, the clamping screw 31 is unscrewed and the nut 34 is rotated such that the head 33 is swung away from the opening of the main portion 20. The closure portion 21 is pivoted to the open position shown in FIG. 11. In this position, the opening to the main portion 20 is unobstructed allowing the reaction vessel R to be slid into place with the flange 7 supported or the supports 25, the ramp surfaces 26 assist in guiding the flange into place in the position shown in FIGS. 12 to 14. Once in place, the closure portion 21 is swung shut and the clamping screw 31 is swung into place such that a shaft 35 of the clamping screw enters a corresponding groove 36 in the closure portion 21. The head 33 is then rotated screwing the clamping screw into place such that the head 33 pushes against the closure portion 21 thereby progressively tightening the three clamping members 23, 24 onto the flange 7 on the reaction vessel.

To release the reaction vessel R, the clamping screw 31 is unscrewed allowing the closure portion 21 and clamping member 33 to be swung back out to the position shown in FIG. 11 whereby the reaction vessel can be slid out.

As will be appreciated particularly from a consideration of FIG. 14, the supports 25 are positioned in front of a notional median plane perpendicular to the direction of insertion through the centre of the reaction vessel R in the clamped position. In the clamping position shown in FIG. 14, the majority of each support is not directly beneath the flange 7. In this position, the flange is supported by a combination of the supports 25 and the three clamping members 23, 24. When the closure portion 21 is open, the reaction vessel R can be slid forward into a position in which the supports are or diametrically opposed sides of the reaction vessel R in which portion the flange 7 will be in front of the two clamping members 23. This means that the lid can be lifted vertically from the reaction vessel while the reaction vessel remains supported by the supports 25. Whilst this arrangement is described with reference to the above example, this can be applied more widely and, indeed, is also present in the subsequently described examples.

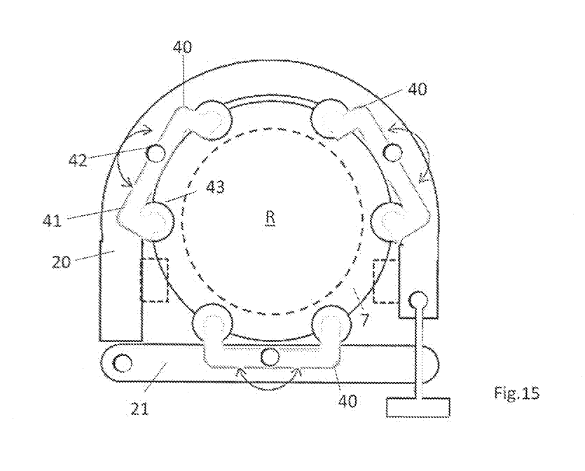

A second example of a ring is shown in FIG. 15. In the previously described example, there were only three clamping points and the only degree of freedom is the degree to which the closure portion 21 is urged against the main portion 20 by the clamping screw 31. In FIG. 15, the clamping members 23, 24 are replaced by more complex clamping members 40, each of these comprises a support arm 41 mounted to a main portion 20 or closure portion 21 via a pivot 42. At each end of the arm 40 is a clamping member 43 which engages with the flange 7. As will be appreciated by comparison of FIGS. 14 and 15, the arrangement in FIG. 15 has six engagement points as compared to the three of FIG. 14. This helps in distributing the clamping force around the reaction vessel R and will therefore be more suitable for larger vessels. The extra degree of freedom provided by the pivots 42 ensures that all of the clamping members 43 will engage with the flange 7.

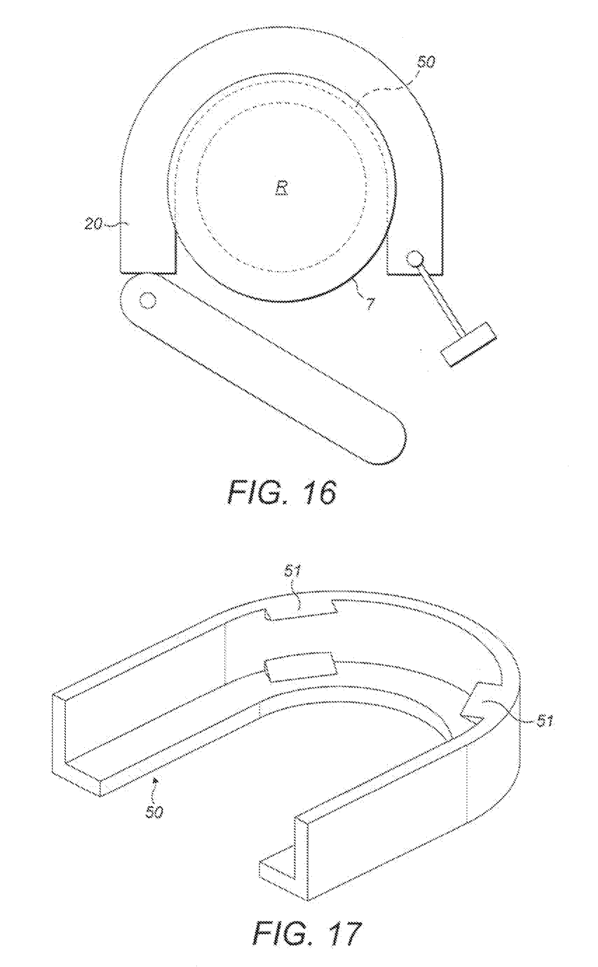

An alternative support arrangement is shown in FIG. 16. instead of the two separate supports 25 described in the previous examples, this arrangement has a lip 50 which extends around the lowermost edge of the main portion 20 so as to provide a support for the flange 7 around a significant portion of its periphery.

FIGS. 17 to 19 show three alternative ways in which the arrangement of FIG. 16 with a single support might be implemented. FIG. 17 shows a pair of clamping members 51 which are integral with the main portion 20. These are positioned far enough from the open end of the main portion that the lip 50 can still support the flange 7 in a forward position in which the lid is clear of the clamping members 51.

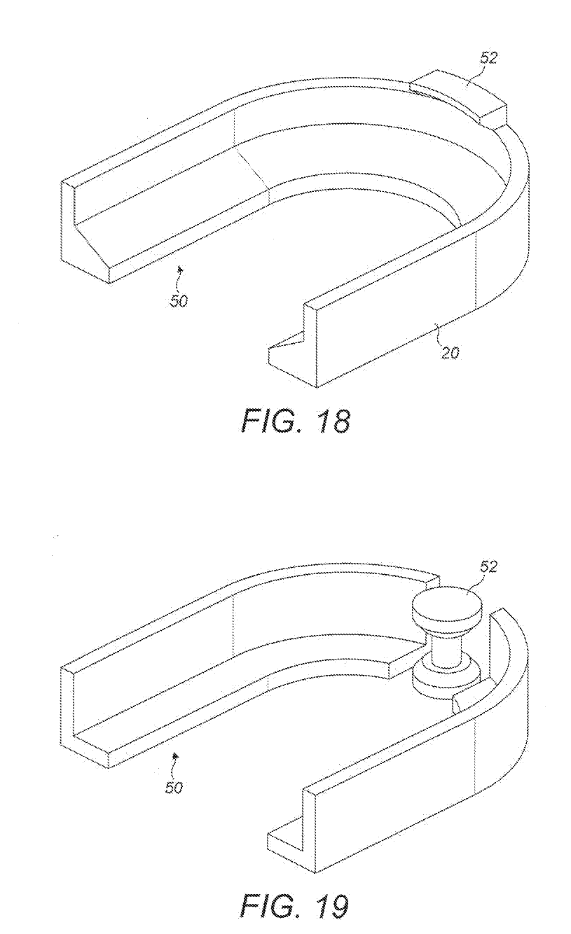

FIG. 18 has a similar arrangement with a single clamping member 52 at the part of the main portion 20 furthest from the open end. In this case, two clamping members may be provided on the closure portion 21.

FIG. 19 is an arrangement similar to FIG. 18, in which the clamping member 52 is a component which is separate from the main portion 20, but is positioned similarly to FIG. 18 and, again, two clamping members may be provided on the closure portion 21.

What is claimed is:

1. A ring for clamping and supporting a reaction vessel having a radial flange at a junction between a vessel body and a vessel lid, the ring being capable of clamping around the flange to clamp the lid to the body and supporting the reaction vessel, the ring comprising:
a two-part collar comprising a U-shape- main portion wide enough at one end to receive the flange of the reaction vessel in a direction parallel to the plane of the ring and a closure portion moveable with respect to the main portion to close the collar, the collar having at least one support that fits, in use, under the flange of the reaction vessel to support the reaction vessel, and
at least one clamping member that is arranged to engage above and below the flange to clamp the lid to the body when the collar is closed;
wherein at least two supports are provided in the main portion, one or each side of the U-shaped main portion, these supports extending in front of the centre of the ring towards one end such that, in use, they are positioned in front of a notional median plane perpendicular to the direction of insertion through the centre of the reaction vessel in the clamped position.

2. A ring according to claim 1, wherein the closure portion is connected at one end to the main portion by a hinge.

3. A ring according to claim 2, wherein the closure portion is connected to the main portion at the end opposite the first end by a screw threaded fastener.

4. A ring according to claim 3, wherein the screw threaded fastener has a screw threaded portion that engages with the main portion and a head that abuts against the closure portion.

5. A ring according to claim 4, wherein the screw threaded portion that engages with the main portion engages with a component which is rotatably mounted within the main portion such that the fastener can be swung into place to engage in a groove in the closure member before the head is screwed into the screw threaded portion to abut against the closure portion.

6. A ring according to claim 1, wherein there are three clamping members.

7. A ring according to claim 1, wherein the clamping members are floating to ensure even distribution of the clamping force during the clamping process.

8. A ring according to any claim 1, wherein there are a plurality of supports distributed around the collar.

9. A ring according to claim 8, wherein there are two supports one on each side of the U-shaped main portion.

10. A ring according to claim 1, wherein the support is arranged such that it is closer to the one end of the ring than the or each clamping member is to support the flange in a second position which is closer to the one end of the ring than the position in which the flange is clamped, and in which the clamping member does not engage with the flange to allow removal of the vessel lid.

11. A ring according to claim 1, wherein the main portion has a single component that subtends an angle of greater than 180° at the centre of the ring.

12. A stand comprising:
a base arranged to support the stand on a horizontal surface, and
a support arm attached to the base at one end and to a ring at the opposite end;
wherein the ring is for clamping and supporting a reaction vessel having as radial flange at a junction between a vessel body and a vessel lid, the ring being capable of clamping around the flange to clamp the lid to the body and supporting the reaction vessel, the ring comprising.
a two-part collar comprising a U-shape main portion wide enough at one end to receive the flange of the reaction vessel in a direction parallel to the plane of the ring and a closure portion moveable with respect to the main portion to close the collar, the collar having at least one support that fits, in use, under the flange of the reaction vessel to support the reaction vessel, and
at least one clamping member that is arranged to engage above and below the flange to clamp the lid to the body when the collar is closed;
wherein at least two supports are provided in the main portion, one on each side of the U-shaped main portion, the supports extending in front of the centre of the ring towards one end such that, in use, they are positioned in front of a notional median plane perpendicular to the direction of insertion through the centre of the reaction vessel in the clamped position.

13. A stand according to claim 12, wherein the ring is supported by the arm at the side of the ring opposite to the closure portion.
